(19) United States
(12) Patent Application Publication
(10) Pub. No.: US 2011/0045114 A1
(43) Pub. Date: Feb. 24, 2011

(54) CHOCOLATE MOLDING TRAY FOR A CHOCOLATE MANUFACTURING APPARATUS AND RELATED APPARATUS AND METHOD

(76) Inventor: Henry M. Whetstone, JR., St. Augustine, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 12/544,032

(22) Filed: Aug. 19, 2009

(51) Int. Cl. A23G 1/26; A23G 1/04; A23G 1/20

(52) U.S. Cl. 425/183; 264/219

(57) ABSTRACT

A chocolate manufacturing machine includes a conveyor to advance a plurality of chocolate molding trays from a chocolate dispenser to a chocolate cooler downstream therefrom. The chocolate molding trays each have a face defining at least one chocolate mold cavity and have a back opposite the face. A plurality of face alignment features are associated with the face of each chocolate molding tray. Further, a plurality of back alignment features are associated with the back of each chocolate molding tray. The face and back alignment features permit alignment of an adjacent pair of chocolate molding trays in a face-to-face, back-to-back, and face-to-back relationship. The face and back alignment features may also permit vertical stacking and unstacking of adjacent pairs of the chocolate molding trays but limit horizontal movement thereof.

### FIELD OF THE INVENTION

The present invention relates to the field of chocolate production, and, more particularly, to apparatus for chocolate production and related methods.

### BACKGROUND OF THE INVENTION

Chocolate is often produced by a modular molding process, as it allows the arrangement of different process sequences to build a large variety of chocolate products. The basic steps to mold a chocolate product include chocolate mold warming, chocolate deposition, vibrating, and demolding.

The production of a chocolate product by molding begins with the warming of chocolate molds to a suitable temperature so that liquid chocolate deposited therein does not begin to solidify immediately. After warming, the chocolate molds are moved downstream by a conveyor and a precise amount of liquid chocolate, typically at a temperature of 85° F., is deposited into a mold cavity of the chocolate mold.

Next, the chocolate mold is moved downstream to a vibration unit by the conveyor. The vibration unit utilizes mechanical energy to level the liquid chocolate within the mold cavities and to dislodge air bubbles.

After vibration, the chocolate molds are transported downstream to a cooling unit, where the liquid chocolate within the mold cavities is solidified, typically via exposure to cool air, for approximately 5 minutes to 30 minutes. The conveyor then moves the chocolate molds downstream to a separator, which removes the solidified chocolate product from the mold cavities and passes the chocolate product along for packaging.

Since deposition of liquid chocolate into a single mold will result in a chocolate product having a flat surface, the production of three-dimensional chocolate products is often accomplished by stacking two chocolate molds together, front-to-front, in a ‘book’ configuration, after deposition. The molds are later cooled in the cooler in this book configuration. Since molds are vertically stacked in some chocolate chillers, chocolate molds capable of being booked and stacked (to thereby form stacks of books) may be desirable.

A conveyor for a chocolate manufacturing apparatus typically includes a pair of parallel chains fitted with guide projections to advance the chocolate molds along a path of travel. Such chains often collect dirt and germs and may not be easily cleaned. In addition, chains may become worn and lengthened due to thermal expansion, leading to imprecise positioning of chocolate molding trays relative to the chocolate dispenser.

Attempts at producing conveyors for chocolate production apparatus that employ other methods of conveying chocolate molds have been made. U.S. Pat. No. 5,591,464 to Rezno, for example, discloses one such conveyor that employs a driveshaft having conveying screws. The underside of each chocolate mold has downwardly extending projections that engage between threads of the conveying screws. As the driveshaft turns the conveying screws, the chocolate molds are advanced along a path of travel.

Similarly, U.S. Pat. No. 5,683,728 to Cerboni discloses a chocolate mold having guide projections extending downwardly therefrom. A rotary drive screw having a thread that movably engages the guide projections advances the chocolate molds along the path of travel. However, such conveying screws or rotary drive may also be difficult to clean.

Cooling units are typically compact to save floor space. For example, a chocolate production apparatus that processes 30 chocolate molds per minute, each requiring 20 minutes of cooling, should be able to cool 600 chocolate molds at one time. Conventional chocolate cooling units include parallel chains that engage with mold movement guides to thereby advance molds through the cooler. The parallel chains move molds in a vertically ascending path as they enter the chocolate cooler. As the molds approach the top of the chocolate cooler, the chains move the molds along a horizontal path, then in a vertically descending path. At the end of the vertically descending path, an actuator moves the molds out of the cooler.

However, such chocolate coolers run at a set speed, and may not be easily adjusted to alter the dwell time of the molds. Furthermore, the molds may be exposed to potential contamination from oil and dirt collected by the parallel chains. Therefore, attempts at improved chocolate coolers have been made. For example, U.S. Pat. No. 6,223,881 to Carle discloses a chocolate cooler that operates similar to the chocolate coolers described above, but employs worm screws rather than chains to move the molds along the vertically ascending and descending paths. While this design may mitigate some issues caused by the use of chains, it still may not be easily adjusted to alter dwell time of the molds, and may still expose the molds to contamination from oil and dirt collected by the worm screws.

U.S. Pat. No. 5,569,472 to Cerboni, for example, discloses a continuously operated chocolate cooler. The chocolate cooler includes a stacker for stacking and lifting molds after entry into the chocolate cooler. The stacked molds are then conveyed in a vertically ascending path by a piston. At the top of the vertically ascending path, a carrier moves the stacks to a top of a vertically descending path where they are lowered along the vertically descending path by a piston. An unstacker unstacks the molds before they are conveyed out of the chocolate cooler. This chocolate cooler design may not allow easy adjustment of the dwell time of molds. Further, it may not be able to adjust to accommodate a ‘missing’ mold.

### SUMMARY OF THE INVENTION

In view of the foregoing background, it is therefore an object of the present invention to provide a chocolate molding tray that may be stacked with adjacent chocolate molding trays in a variety of configurations.

This and other objects, features, and advantages in accordance with the present invention are provided by a chocolate manufacturing apparatus that may comprise a chocolate dispenser and a chocolate cooler downstream from the chocolate dispenser. A plurality of chocolate molding trays may each have a face defining at least one chocolate mold cavity and have a back opposite the face. A conveyor may be for advancing the plurality of chocolate molding trays from the chocolate dispenser to the chocolate cooler.

A plurality of face alignment features may associated with the face of each chocolate molding tray and a plurality of back alignment features may be associated with the back of each chocolate molding tray. The pluralities of face and back alignment features may permit alignment of an adjacent pair of chocolate molding trays, in a face-to-face, back-to-back, and face-to-back relationship. The pluralities of face and back alignment features may also permit vertical stacking and unstacking of adjacent pairs of the chocolate molding trays but limit horizontal movement thereof. This permits the trays to be used in a variety of different configurations.

Each of the plurality of chocolate molding trays may have a generally rectangular base and a pair of opposing sidewalls extending therefrom. The plurality of back alignment features may be associated with the pair of opposing sidewalls and the plurality of face alignment features may be associated with the generally rectangular base.

The plurality of face alignment features may comprise a set of face alignment recesses in the face and a set of face alignment projections on the face. The set of face alignment projections may be movable between an extended position and a retracted position.

The set of face alignment recesses may be defined adjacent a perimeter of the face and the set of face alignment projections may extend from the face adjacent the perimeter thereof. Opposite pairs of face alignment recesses may be offset from each other and opposite pairs of face alignment projections may be offset from each other.

The back alignment features may comprise a set of back alignment recesses defined in the pair of opposing sidewalls and a set of back alignment projections extending from the pair of opposing sidewalls. The set of back alignment recesses may be defined adjacent a perimeter of the pair of opposing sidewalls and the set of back alignment projections may extend from the pair of opposing sidewalls adjacent the perimeter thereof.

Opposite pairs of back alignment recesses may be offset from each other. Opposite pairs of back alignment projections may also be offset from each other.

A chocolate vibration apparatus may be downstream of the chocolate dispenser and upstream of the chocolate cooler. A chocolate separator may be downstream of the chocolate cooler.

A method aspect is directed to a method of making a chocolate molding tray for use in a chocolate manufacturing apparatus comprising a chocolate dispenser, a chocolate cooler downstream from the chocolate dispenser, and a conveyor to advance the chocolate molding tray from the chocolate dispenser to the chocolate cooler. The method may comprise forming a generally rectangular base, having at least one chocolate mold cavity, and a pair of opposing sidewalls extending therefrom. The method may also include forming a plurality of face alignment features associated with the generally rectangular base. The method may further include forming a plurality of back alignment features associated with the pair of opposing sidewalls. The pluralities of face and back alignment features may permit alignment of the chocolate molding tray with an adjacent chocolate molding tray in a face-to-face, back-to-back, and face-to-back relationship.

### BRIEF DESCRIPTION OF THE DRAWINGS

FIG. 1 is a block diagram of a chocolate manufacturing apparatus, in accordance with the present invention.

FIG. 2 is a front perspective view of a chocolate molding tray used by the chocolate manufacturing apparatus of FIG. 1.

FIG. 3 is a bottom perspective view of the chocolate molding tray of FIG. 2.

FIG. 4 is a side view of the chocolate molding tray of FIG. 2.

FIG. 5 is a side perspective view of two ‘books’ of the chocolate molding trays of FIG. 2 stacked together.

FIG. 6 is a side perspective view of a stack of the chocolate molding trays of FIG. 2.

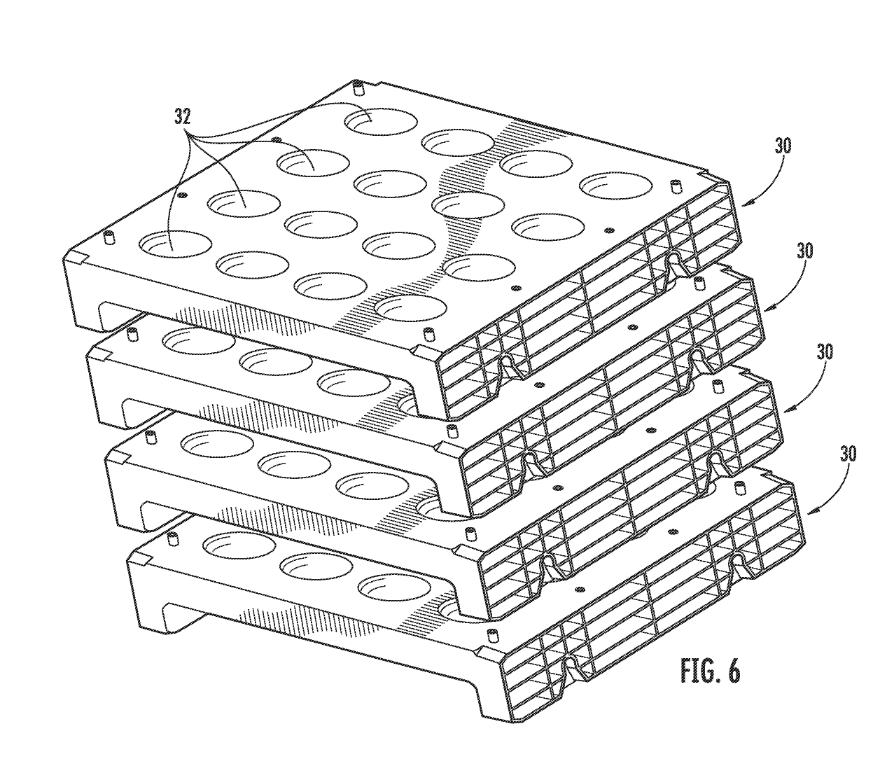

FIG. 7 is a flowchart of a method of making a chocolate manufacturing apparatus, in accordance with the present invention.

FIG. 8 is a perspective view of the conveyor of FIG. 1.

FIG. 9 is a front perspective view of the conveyor of FIG. 1.

FIG. 10 is a schematic block diagram of the conveyor of FIG. 1.

FIG. 11 is a flowchart of another method of making a chocolate manufacturing apparatus, in accordance with the present invention.

FIG. 12 is a schematic block diagram of an alternative embodiment of a chocolate manufacturing apparatus including a stacker and an unstacker, in accordance with the present invention.

FIG. 13 is a schematic block diagram of an alternative embodiment of the chocolate cooler of FIG. 12.

FIG. 14 is a side view of the chocolate cooler of FIG. 13.

FIG. 15 is a side view of a group of vertical stacks as assembled by the stacker of FIG. 12.

FIG. 16 is a flowchart of a method of making chocolate using a chocolate manufacturing apparatus, in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notation is used to indicate similar elements in alternative embodiments.

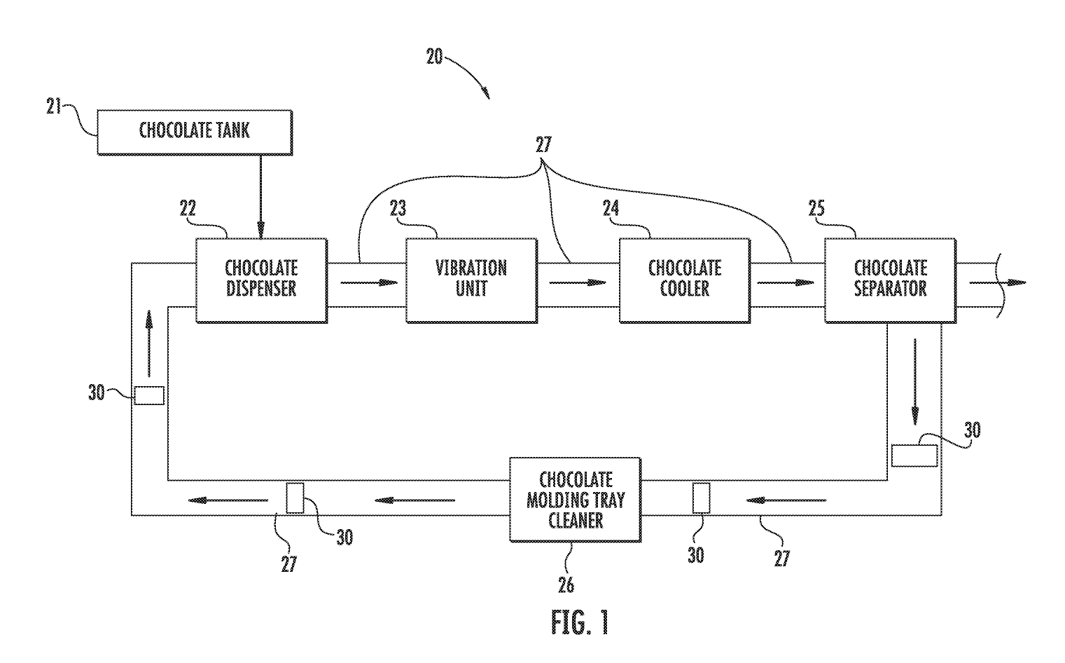

Referring initially to FIG. 1, a chocolate manufacturing apparatus 20 includes a chocolate tank 21 in fluid communication with a chocolate dispenser 22. The chocolate tank 21 may be heated so that the liquid chocolate therein remains at a suitable temperature for chocolate manufacturing, typically 85° F., although those skilled in the art will appreciate that the liquid chocolate may be held at other temperatures.

Liquid chocolate is pumped from the chocolate tank 21 to the chocolate dispenser 22, which dispenses a precise amount of liquid chocolate into a mold cavity of each of a plurality of chocolate molding trays 30 in turn (further details of suitable chocolate molding trays will be given below). The chocolate dispenser 22 may be any suitable conventional chocolate dispenser and may fill each mold cavity using a plurality of chocolate dispensing nozzles (not shown). Those skilled in the art will understand that the chocolate dispenser 22 may also dispense inclusions, such as rice and nuts together with the liquid chocolate.

After chocolate dispensing, a conveyor 27 (further details of which will be given below) advances the molding trays 30 downstream to a vibration unit 23. The vibration unit 23 spreads the liquid chocolate evenly in the mold cavity and forces trapped air bubbles out of the mold cavity by applying mechanical vibration to the molding trays. The mechanical vibration is preferably vertical in direction, although in some applications the vibration may additionally or alternatively be horizontal in direction. Each chocolate molding tray 30 should helpfully spend at least 30 seconds, and preferably 55-60 seconds, in the vibration unit, although other vibrations times may also be used. Those skilled in the art will understand that any suitable vibration unit 23 may be used and that, in some embodiments, the vibration unit may not be present.

After advancing the chocolate molding trays through the vibration unit 23, the conveyor 27 advances the chocolate molding trays 30 downstream to a chocolate cooler 24 (further details of which will be provided below). The chocolate cooler 24 cools the liquid chocolate in the chocolate molding trays 30 so that it solidifies, preferably at a cooling temperature of 48°-65° F., although other cooling temperatures may be used. In some embodiments, different portions of the chocolate cooler 24 may be kept at different cooling temperatures, and the chocolate molding trays 30 may be advanced among these different portions.

After the liquid chocolate in the mold cavities of the chocolate molding trays 30 is cooled by the chocolate cooler 24 to solidification, the conveyor 27 advances the chocolate molding trays downstream to a chocolate separator 25 or demolder. The chocolate separator 25 removes the chocolate from the molding cavities for packaging and/or further processing. The chocolate molding trays 30 emerge from the chocolate separator 25 empty and are advanced yet again by the conveyor 27 downstream to a chocolate molding tray cleaner 26.

The chocolate molding tray cleaner 26 cleans the chocolate molding trays 30 to keep them sanitary and to remove excessive chocolate that has built up on surfaces of the chocolate molding trays. In addition, the chocolate molding tray cleaner 26 may heat the chocolate molding tray 30 so that when liquid chocolate is deposited into their molding cavities, downstream at the chocolate dispenser 22, it does not solidify at an premature point in time. The chocolate molding tray cleaner 26 may be of the kind commonly known to those of skill in the art and may employ cleaning rollers and scrapers. After being cleaned and heated, the chocolate molding trays 30 are advanced downstream by the conveyor 27 to the chocolate dispenser 22 and the chocolate manufacturing process begins again. In some embodiments, the chocolate molding tray cleaner 26 may not be needed.

Those skilled in the art will understand that the chocolate manufacturing apparatus 20 may include additional portions. For example, an auger mixer may mix inclusions such as nuts and rice with the liquid chocolate prior to dispensing.

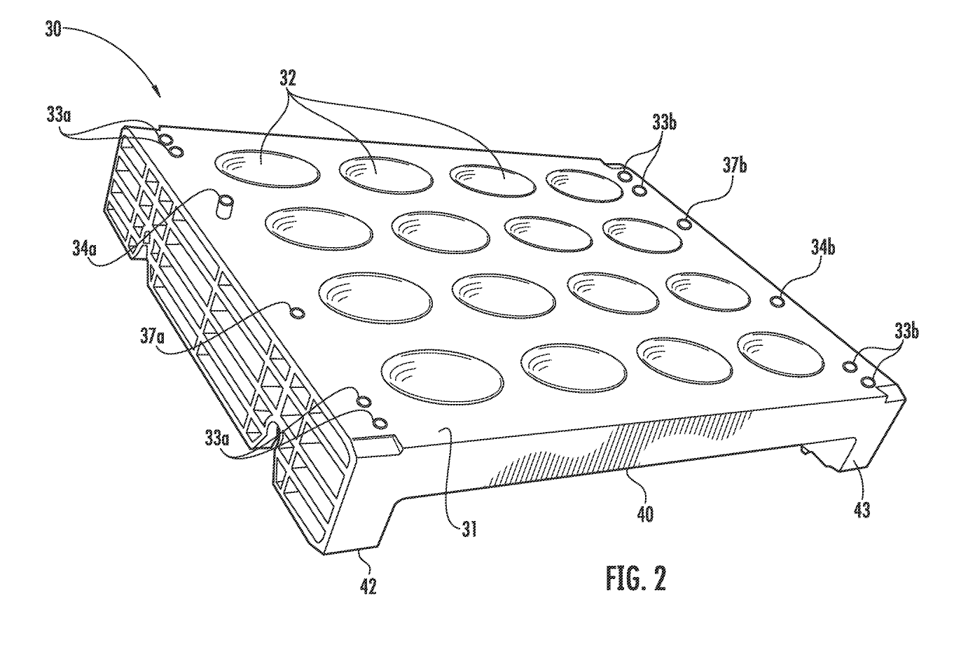

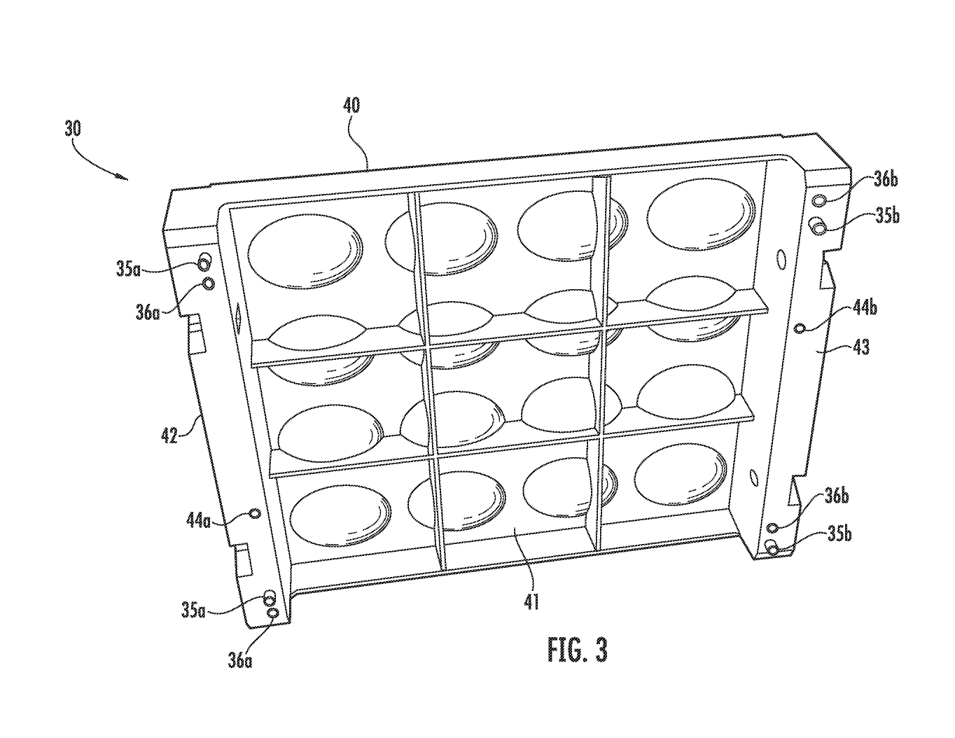

Details of chocolate molding trays 30 will now be given with reference to FIGS. 2-4. The chocolate molding tray 30 has a generally rectangular base 40 and a pair of opposing sidewalls 42, 43 extending therefrom. A portion of the rectangular base 40 has a face defining a plurality of chocolate mold cavities 32. The chocolate mold cavities 32 receive liquid chocolate dispensed by the chocolate dispenser 22, as described above.

Face alignment features 33a, 33b, 34a, 34b, 37a, 37b are associated with the face 31 of the chocolate molding tray 30. The chocolate molding tray 30 has a back 41 opposite the face 31, and back alignment features 35a, 35b, 36a, 36b, 44a, 44b are associated therewith. The face alignment features 33a, 33b, 34a, 34b, 37a, 37b and back alignment features 35a, 35b, 36a, 36b, 44a, 44b permit alignment of an adjacent pair of chocolate molding trays in a face-to-face, back-to-back, and face-to-back relationship, as explained in greater detail below.

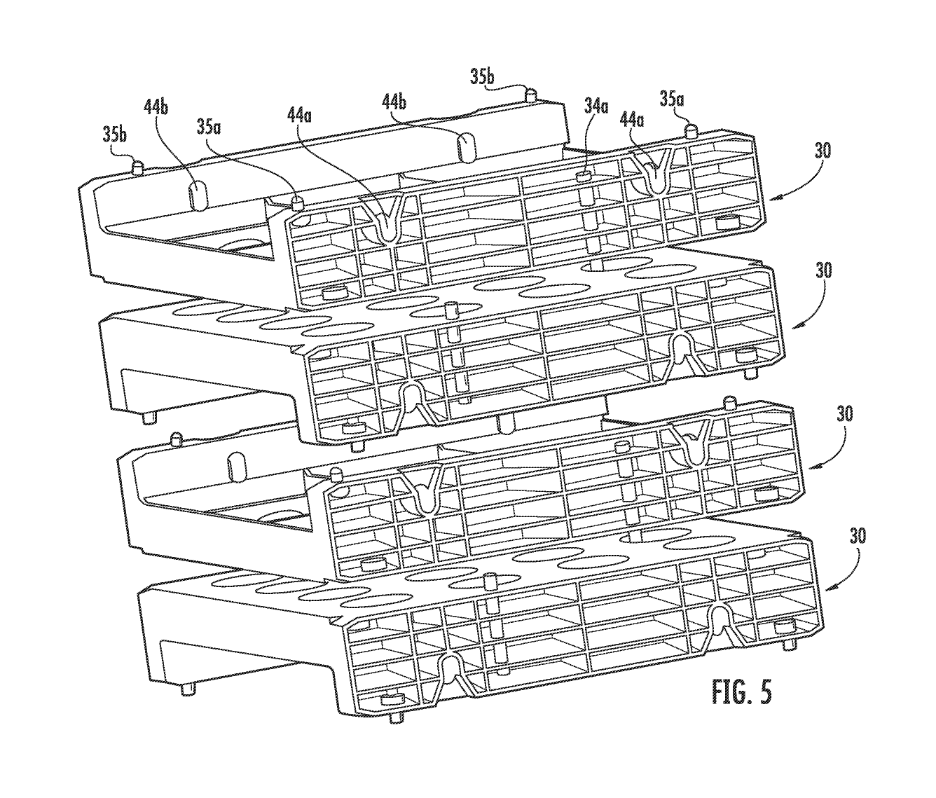

Chocolate molding trays 30 arranged in a face-to-face relationship, and back-to-back relationship, are illustrated in FIG. 5. The capability of these chocolate molding trays 30 to be arranged in face-to-face and back-to-back relationships is advantageous because, as explained above, deposition of liquid chocolate into a single chocolate molding tray may result in a chocolate product having a flat surface. Therefore, the production of three-dimensional chocolate products may be accomplished by stacking two chocolate molding trays 30 together, front-to-front, in a ‘book’ configuration, after chocolate deposition. Further, since the chocolate molding trays 30 may be vertically stacked in the chocolate cooler 24 (FIG. 1), as will be explained in further detail below, it is desirable to be able to form a stack of books, as shown in FIG. 5. Moreover, the capability of the chocolate molding trays 30 to be arranged in a face-to-back relationship is advantageous for ease of cleaning and storage.

The face alignment features 33a, 33b, 34a, 34b, 37a, 37b and back alignment features 35a, 35b, 36a, 36b, 44a, 44b not only permit vertical stacking and unstacking of adjacent pairs of chocolate molding trays 30, but also limit horizontal movement thereof, helping to stabilize a stack of chocolate molding trays.

In particular, the face alignment features 33a, 33b, 37a, 37b are a set of face alignment recesses defined adjacent a perimeter of the face 31. Of course, the face alignment recesses 33a, 33b, 37a, 37b need not be adjacent a perimeter of the face 31, and in some embodiments may not be. The opposite face alignment recesses 37a, 37b are offset from each other, as shown in FIG. 2. The offset arrangement of the opposite face alignment recesses 37a, 37b advantageously adds stability to a stack of chocolate molding trays 30.

In addition, the face alignment features 34a, 34b are a set of face alignment projections extending from the face 31 adjacent a perimeter thereof. Skilled artisans will appreciate that the face alignment projections 34a, 34b need not be adjacent a perimeter of the face 31. The opposite face alignment projections 34a, 34b are also offset from each other, and this offset arrangement helps stabilize a stack of chocolate molding trays 30.

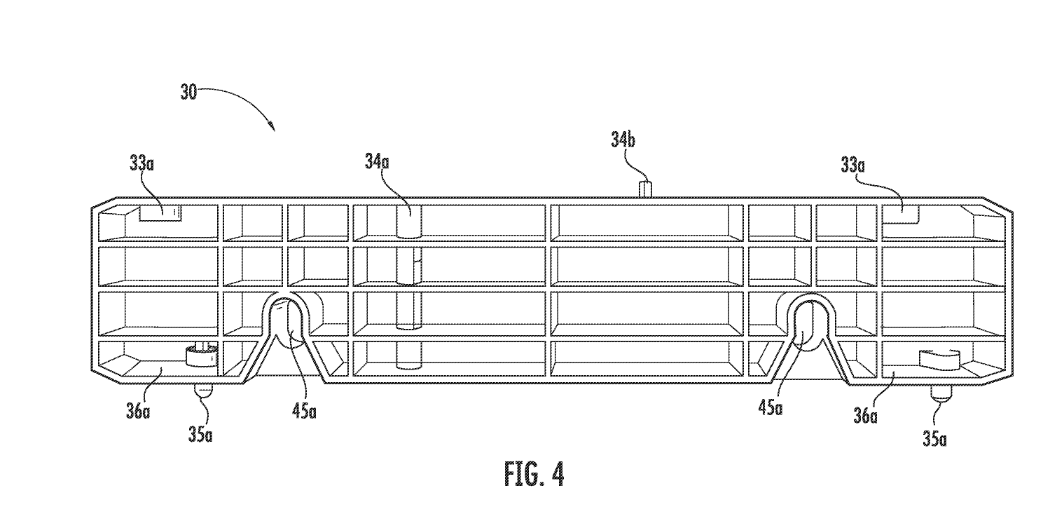

The face alignment projections 34a, 34b are movable between an extended position (FIG. 2) and retracted position (FIG. 4), although it should be understood that these face alignment projections may be fixed (or, indeed, not present) in some embodiments. When in the extended position, the face alignment projections 34a, 34b facilitate arrangement of an adjacent pair of chocolate molding trays 30 in a face-to-face relationship. For ease of cleaning and/or storage, the face alignment projections 34a, 34b may be in the retracted position.

The back alignment features 35a, 36a, and 44a are associated with the sidewall 42. The back alignment features 35b, 36b, and 44b are associated with the sidewall 43. In particular, the back alignment features 35a, 35b are a set of back alignment projections extending from the sidewalls 42, 43, respectively, adjacent the perimeters thereof. The back alignment features 36a, 44a comprise back alignment recesses defined in the sidewall 42 adjacent a perimeter thereof. Similarly, the back alignment features 36b, 44b also comprise back alignment recesses defines in the sidewall 43 adjacent a perimeter thereof.

Opposite pairs of back alignment projections 35a, 35b are offset from each other. Likewise, opposite pairs of back alignment recesses 36a, 36b, 44a, 44b are offset from each other. This offset arrangement helps stabilize stacks of chocolate molding trays 30.

It should be understood that the face alignment features 33a, 33b, 34a, 34b, 37a, 37b and back alignment features 35a, 35b, 36a, 36b, 44a, 44b need not be arranged as illustrated and may take any number of other configurations. Likewise, there may be any number of face alignment features and back alignment features.

In some applications, the conveyor 27 (FIG. 1) may have a plurality of conveyance projections (not shown) and the sidewalls 42, 43 of the chocolate molding tray 30 may have conveyance recesses 45a and 45b (not shown) to receive the conveyance projections. This allows such a conveyor 27 (FIG. 1) to securely engage the chocolate molding tray 30 for advancement downstream.

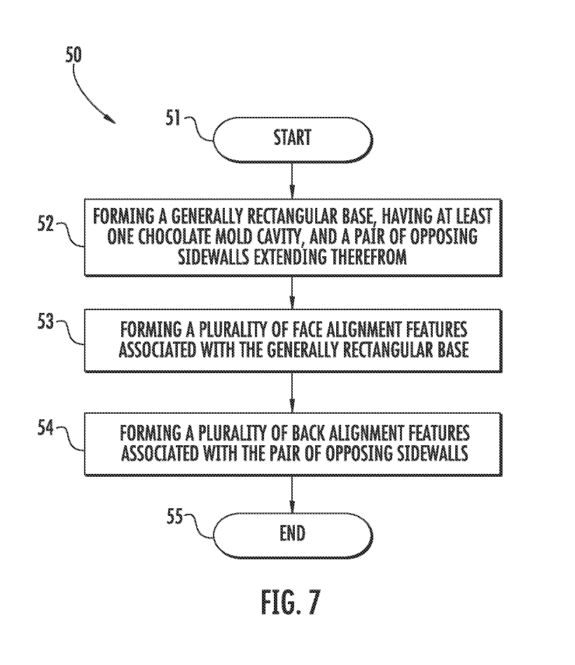

With reference to the flowchart 50 of FIG. 7, a method of making a chocolate molding tray for use in a chocolate manufacturing apparatus comprising a chocolate dispenser, a chocolate cooler downstream from the chocolate dispenser, and a conveyor to advance the chocolate molding tray from the chocolate dispenser to the chocolate cooler, is now described. After the start (Block 51), at Block 52, a generally rectangular base, having at least one chocolate mold cavity and a pair of opposing sidewalls extending therefrom, is formed.

At Block 53, a plurality of face alignment features associated with the generally rectangular base are formed. At Block 54, a plurality of back alignment features associated with the pair of opposing sidewalls are formed. Block 55 indicates the end of the method.

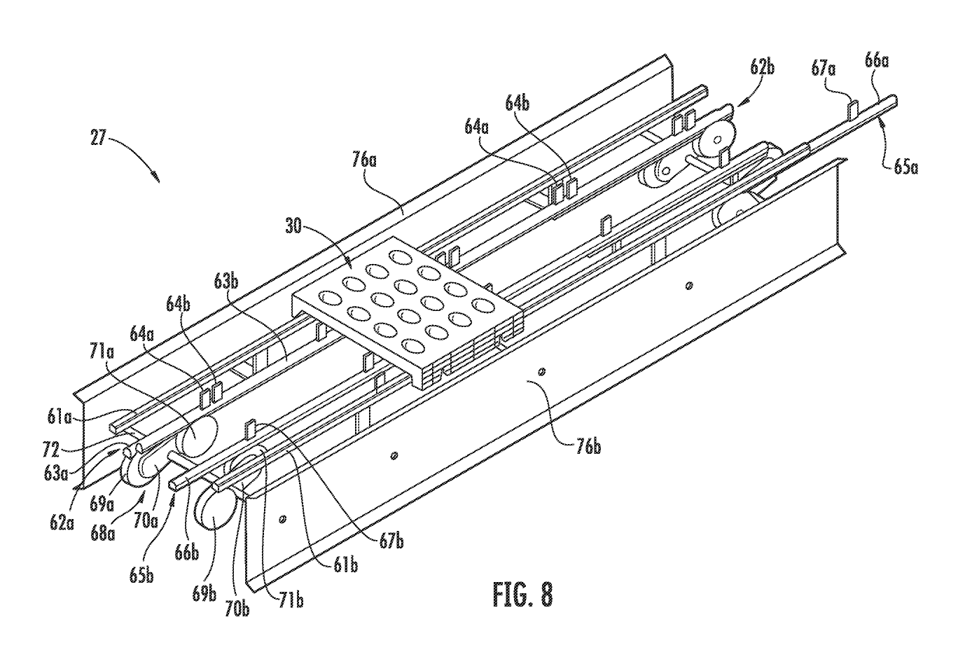

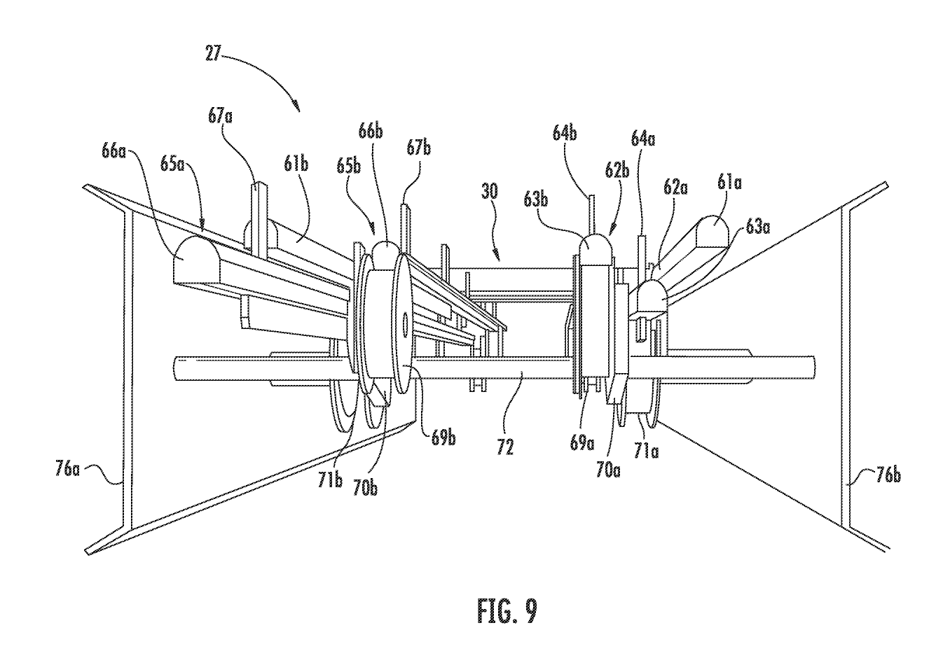

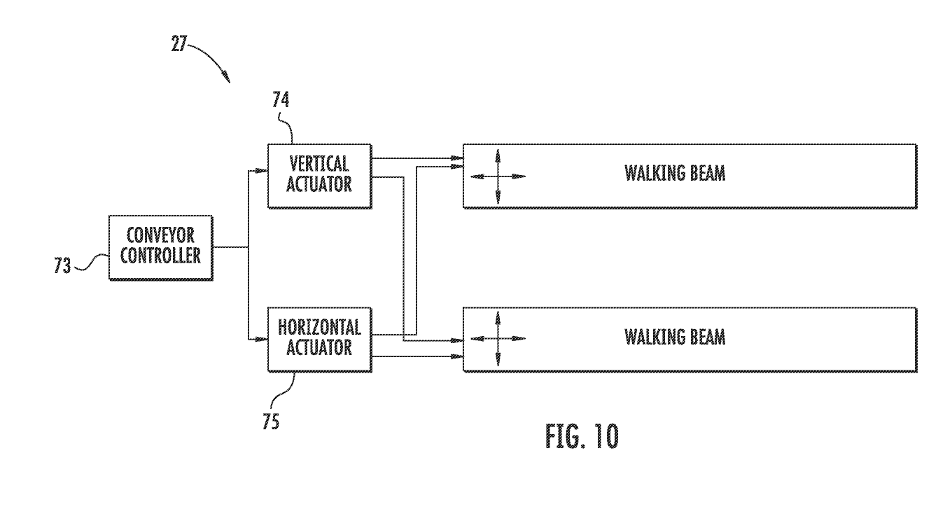

With reference to FIGS. 8-10, details of a portion of the conveyor 27 (FIG. 1) will now be discussed. The conveyor 27 comprises a walking beam conveyor to advance the plurality of chocolate molding trays along a path of travel from the chocolate dispenser 22 (FIG. 1) toward the chocolate cooler 24 (FIG. 1).

When advancing the chocolate molding trays through the vibration unit 23 (FIG. 1), the walking beam conveyor 27 constrains movement of the chocolate molding trays 30 from an upstream direction. The walking beam conveyor 27 performs this function even when the movement thereof is halted. This may be particularly advantageous when the walking beam conveyor 27 is halted, yet the vibration unit 23 (FIG. 1) remains online. If a chocolate molding tray 30 were to move upstream at such a time, once the walking beam conveyor 27 was reactivated, a malfunction might occur in the absence of this feature.

The walking beam conveyor 27 may be devoid of chains along the path of travel. Chains may wear and become irregularly lengthened due to thermal expansion. This might lead to imprecise positioning of the chocolate molding trays 30 relative to the chocolate dispenser 22 (FIG. 1), vibration unit 23 (FIG. 1), chocolate cooler 24 (FIG. 1), chocolate separator 25 (FIG. 1), and chocolate molding tray cleaner 26 (FIG. 1). The result of such an imprecise positioning may be an improperly molded chocolate product, or a chocolate product of poor quality. Moreover, grease and dirt may become trapped in chains, and this may contaminate the chocolate product. Such a walking beam conveyor 27 being devoid of chains along the path of travel would help avoid these issues.

The walking beam conveyor comprises a pair of side panels 76a, 76b and a pair of spaced apart tray guide rails 61a, 61b therebetween to guide the chocolate molding trays 30. The tray guide rails 61a, 61b are designed to be positioned inwardly of the sidewalls 42, 43 (FIG. 2) of the chocolate molding trays 30 (FIG. 2) as the chocolate molding trays advance along the path of travel. This helps to constrain the chocolate molding trays 30 from undesired horizontal movement.

First and second pairs of walking beams 62a, 62b, and 65a, 65b are adjacent the pair of spaced apart tray guide rails 61a, 61b. A drive arrangement (not shown) actuates the walking beams 62a, 62b, 65a, 65b to thereby advance the chocolate molding trays 30 along the path of travel.

In particular, the first pair of walking beams 62a, 62b each comprises a longitudinal member 63a, 63b and a plurality of fingers 64a, 64b extending upwardly therefrom, respectively. Similarly, the second pair of walking beams 65a, 65b each comprises a longitudinal member 66a, 66b and a plurality of fingers 67a, 67b extending upwardly therefrom.

The drive arrangement alternatingly cycles the first and second pairs of walking beams 62a, 62b and 65a, 65b between advance and return directions and so that at least some fingers thereof are in contact with adjacent chocolate molding trays 30 during changes in direction. Therefore, at least some fingers of the first and second pairs of walking beams 62a, 62b and 65a, 65b may be in contact with the chocolate molding trays 30 at all times. This constrains the chocolate molding trays 30 from upstream movement.

In particular, the first and second pairs of walking beams 62a, 62b and 65a, 65b are cycled by the drive arrangement in parallel. This balances the walking beam conveyor 27, providing for smoother running of the walking beam conveyor, and reducing vibration that might cause advanced component wear or undesirable motion of the chocolate molding trays 30.

Each of the first pair of walking beams 62a, 62b is cycled by the drive arrangement 76 out of phase, preferably 180° out of phase, to balance the walking beam conveyor 27. Each of the second pair of walking beams 65a, 65b is likewise cycled out of phase. This out of phase arrangement further helps to balance the walking beam conveyor 27. As walking beams 62a, 65a are advanced, the fingers 64a, 67a thereof engage the chocolate molding trays 30. Once the walking beams 62a, 65a are fully advanced, they move downward to disengage their fingers 64a, 67a from the chocolate molding trays 30, while the walking beams 62b, 65b move upward so that their fingers 64b, 67b engage the chocolate molding trays 30. The fingers 64a, 67a do not disengage from the chocolate molding trays 30 until the fingers 64b, 67b engage the chocolate molding trays. Once the fingers 64a, 67a are disengaged from the chocolate molding trays 30, the walking beams 62a, 65a are moved in the return direction.

The drive arrangement 76 comprises a vertical actuator 74 and a horizontal actuator 75 coupled to the first and second pairs of walking beams 62a, 62b and 65a, 65b. A conveyor controller 73 is coupled to, and controls, the horizontal actuator 74 and horizontal actuator 75. The vertical actuator 74 moves the first and second pairs of walking beams 62a, 62b and 65a, 65b vertically to engage and disengage the fingers 64a, 64b, and 67a, 67b thereof with the chocolate molding trays 30. The horizontal actuator 75 moves the first and second pairs of walking beams 62a, 62b and 65a, 65b in the advanced direction, thereby advancing the chocolate molding trays 30 along the path of travel The horizontal actuator 75 also moves the first and second pairs of walking beams 62a, 62b and 65a, 65b in the return direction.

The vertical actuator 74 comprises a driveshaft 72 and crosspieces 70a, 70b coupled thereto. First and second pairs of opposing longitudinal walking beam receivers 69a, 71a and 69b, 71b are coupled to the crosspieces 70a, 70b, respectively. A motor (not shown) is coupled to the driveshaft 72 to cyclically rotate the driveshaft in a clockwise and a counterclockwise direction. This moves the first and second pairs of walking beams 62a, 62b and 65a, 65b in vertically upward and vertically downward motions. Those skilled in the art will understand that, rather than a motor, an air cylinder or pneumatic rotary actuator may cyclically rotate the driveshaft 72.

The longitudinal walking beam receivers 69a, 71a and 69b, 71b each illustratively comprise first and second circular bases coupled together by cylindrical intermediate portions having a diameter smaller than the first and second circular bases. However, the longitudinal walking beam receivers 69a, 71a and 69b, 71b may take other suitable shapes, such as rectangles or triangles.

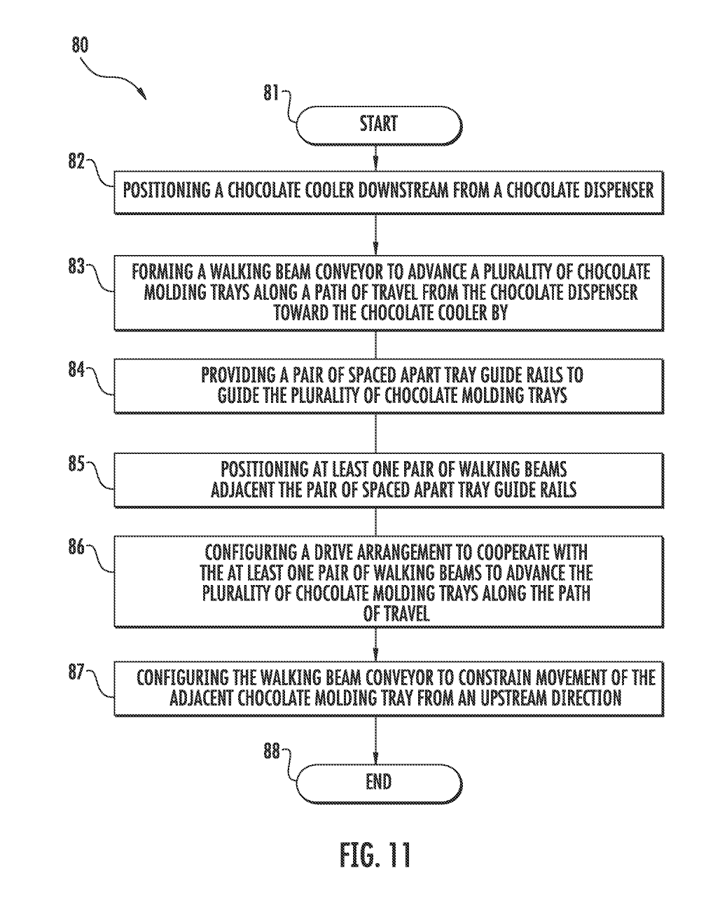

With reference to the flowchart 80 of FIG. 11, another method of making a chocolate manufacturing apparatus us now described. After the start (Block 81), at Block 82, a chocolate cooler is positioned downstream from a chocolate dispenser. At Block 83, a walking beam conveyor is formed to advance a plurality of chocolate molding trays along a path of travel from the chocolate dispenser toward the chocolate cooler.

Blocks 84-86 explain that the walking beam conveyor is formed by (Block 84) providing a pair of spaced apart tray guide rails to guide the plurality of chocolate molding trays, (Block 85) positioning at least one pair of walking beams adjacent the pair of spaced apart tray guide rails, and (Block 86) configuring a drive arrangement to cooperate with the at least one pair of walking beams to advance the plurality of chocolate molding trays along the path of travel.

At Block 87, the walking beam conveyor is configured to constrain movement of an adjacent chocolate molding tray from an upstream direction. Block 88 indicates the end of the method.

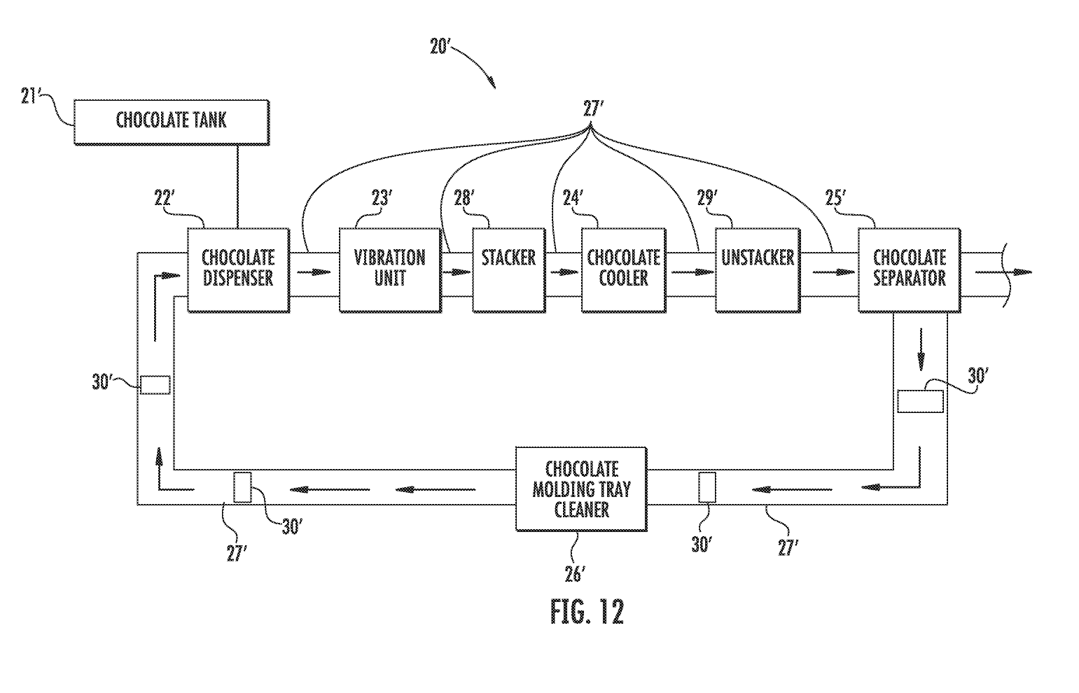

With additional reference to FIG. 12, a further embodiment of the chocolate manufacturing apparatus 20′ is now described. The chocolate tank 21′, chocolate dispenser 22′, vibration unit 23′, chocolate cooler 24′, chocolate separator 25′, chocolate molding tray cleaner 26′, and conveyor 27′ operate as described above with reference to FIG. 1 and require no further discussion herein.

In this embodiment, there is a stacker 28′ downstream from the vibration unit 23′ and upstream of the chocolate cooler 24′. The stacker 28′ assembles a plurality of vertical stacks of chocolate molding trays 30′ for cooling by adding each successive chocolate molding tray to a bottom of a corresponding vertical stack.

Downstream of the chocolate cooler 24′ and upstream of the chocolate separator 25′ is an unstacker 29′. The unstacker 29′ disassembles the plurality of vertical stacks of chocolate molding trays 30′ after cooling by removing successive chocolate molding trays from a top of a corresponding vertical stack.

The stacker 28′ and unstacker 29′ define a first-in-first-out (FIFO) arrangement for the plurality of chocolate molding trays 30′ through the chocolate cooler 24′. A FIFO arrangement is helpful because it helps ensure that each chocolate molding tray 30′ is in the chocolate cooler 24′ for a same time. This is particularly advantageous because it may be desirable for the dwell time of the chocolate molding trays 30′ in the chocolate cooler 24′ to be equal to each other and precisely controlled during the production of certain products, for example, for production of products using a conventional shell molding process.

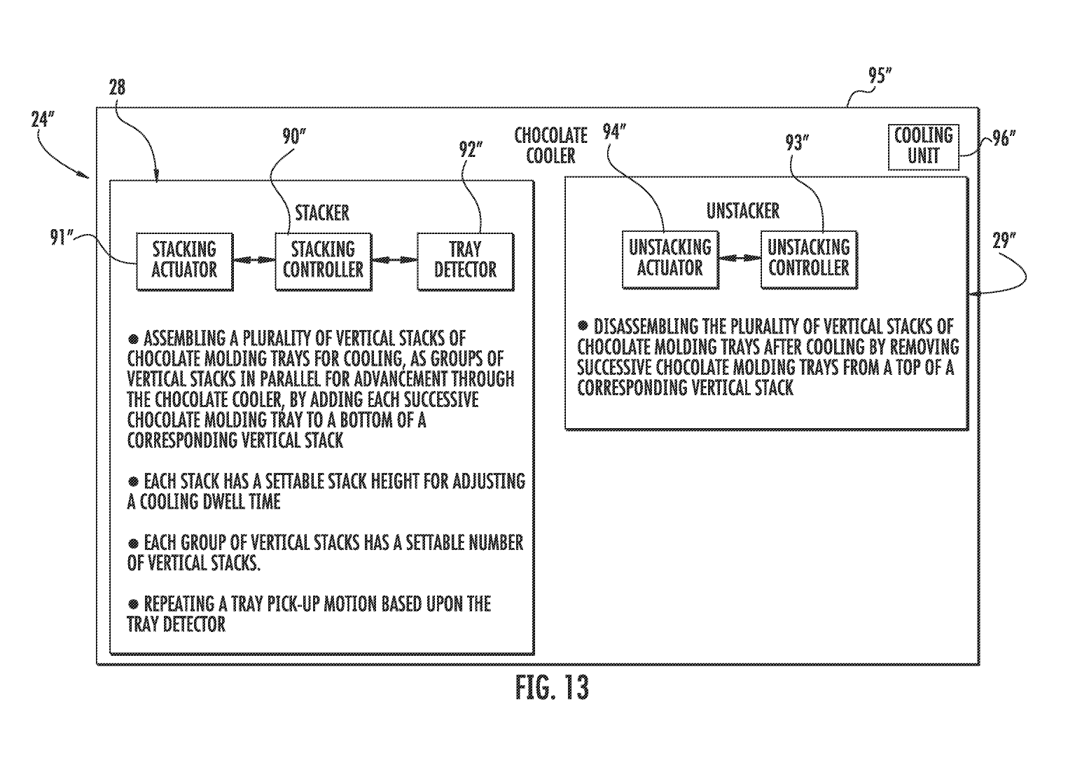

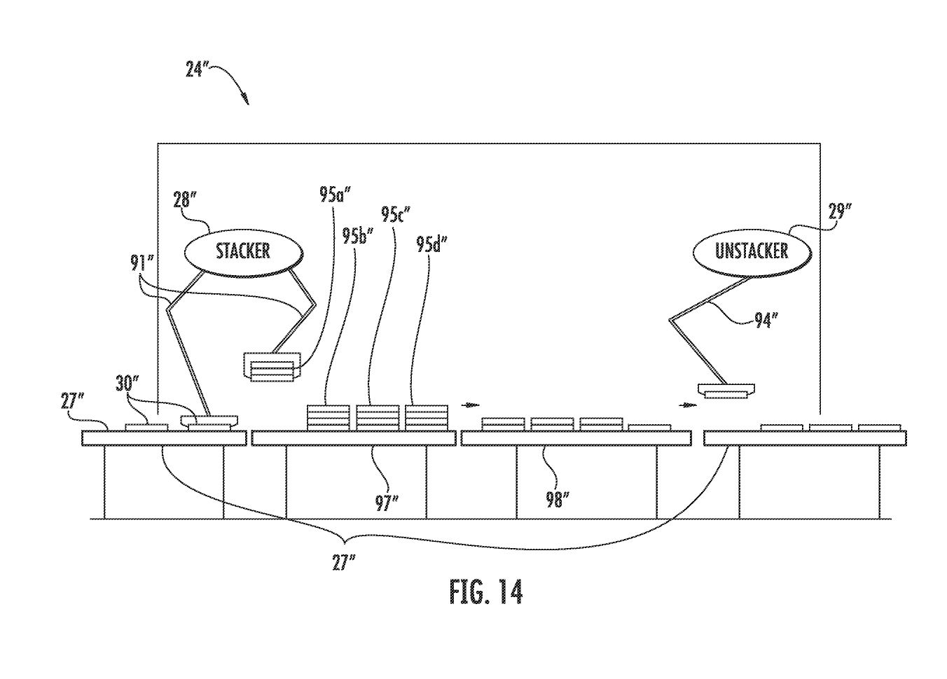

With reference to FIGS. 13-14, an embodiment of the chocolate cooler 24″ comprising a housing 95″ with the stacker 28″ and unstacker 29″ contained therein is now described. A cooling unit 96″ is associated with the housing 95″ for cooling the inside thereof. Although both the stacker 28″ and the unstacker 29″ are contained in the housing 95″ in this embodiment, it should be understood that, in other embodiments, only one may be in the housing, or neither may be in the housing.

The cooling unit 96″ may be conventional cooling unit as known to those skilled in the art, and may cool the interior of the housing 95″ by blowing cool air thereinto. The stacker 28″ comprises a stacking controller 90″ and a stacking actuator 91″ associated therewith. The stacking controller 90″ controls the stacking actuator 91″ for assembling a plurality of vertical stacks of chocolate molding trays 30″ for cooling, as groups of vertical stacks in parallel for advancement through the chocolate cooler 24″, by adding each successive chocolate molding tray to a bottom of a corresponding vertical stack. The stacking actuator 91″ may be any suitable actuator as known to those of skill in the art.

The unstacker 29″ comprises an unstacking controller 93″ and an unstacking actuator 94″ associated therewith. In particular, the unstacking controller 93″ controls the unstacking actuator 94″ for disassembling the plurality of vertical stacks of chocolate molding trays after cooling by removing successive chocolate molding trays 30″ from a top of a corresponding vertical stack. The unstacking actuator 94″ may be any suitable actuator as known to those of skill in the art.

The conveyor 27″ delivers the chocolate molding trays 30″ to the chocolate cooler 24″, as illustrated in FIG. 13. The stacking controller 90″ causes the stacking actuator 91″ to pick up each chocolate molding tray 30″ as it enters the chocolate cooler 24″ and add it to the bottom of a corresponding vertical stack. As shown in FIG. 14, the stacker 28″ is assembling four vertical stacks 95a″-95d″. The stacking controller 90″ allows a number of desired vertical stacks to be chosen together with a stack height for those stacks. In the illustrated example, the stack height has been set at four chocolate molding trays 30″ high. Assembling the vertical stacks 95a″-95d″ in parallel, the stacker 28″ has competed vertical stacks 95b″-95d″.

The stacker 28″ is illustratively picking up the vertical stack 95a″ so that it may place a chocolate molding tray 30″ at the bottom to complete that stack. Once the desired number of vertical stacks 95a″-95d″ has been assembled, a first chocolate cooler conveyor 97″ advances the vertical stacks 95a″-95d″ to a second chocolate cooler conveyor 98″. Once the vertical stacks 95a″-95d″ have been on the second chocolate cooler conveyor 98″ for a desired time, the unstacker 29″ begins disassembling the vertical stacks by removing successive chocolate molding trays from a top of a corresponding vertical stack.

Preferably, the time taken for the stacker 28″ to assemble the vertical stacks 95a″-95d″ is equal to the time taken for the unstacker 29″ to disassemble the vertical stacks. This helpfully provides for continuous movement of the chocolate molding trays 30″ through the chocolate cooler 24″.

Since vertical stacks containing more chocolate molding trays 30″ take a longer time to assemble and disassemble, the dwell time of the chocolate molding trays 30″ in the chocolate cooler 24″ may be adjusted by adjusting the stack height of the vertical stacks. This advantageously allows the chocolate cooler 24″ to easily accommodate a wide variety of chocolate products requiring a variety of different dwell times.

In some applications, the interior temperature of the housing 95″ of the chocolate cooler 24″ may be different at the stacker 28″ than at the unstacker 29″. This advantageously allows for graduated cooling of the chocolate product in the chocolate molding trays 30″.

The stacker 28″ has a tray detector 92″ associated therewith. If the stacker 28″ performs a pick-up motion, but the tray detector 92″ fails to detect that a chocolate molding tray 30″ was picked up, the stacker 28″ repeats the tray pick-up motion. This advantageously preserves the FIFO advancement of the chocolate molding trays 30″ through the chocolate cooler 24″.

Alternatively, there may not be a tray detector 92″. In this case, FIFO advancement of the chocolate molding trays 30″ may not be strictly preserved, but the dwell time of each chocolate molding tray in the chocolate cooler 24″ from that of the other chocolate molding trays may not vary greatly enough to be a concern, depending upon the chocolate product being produced.

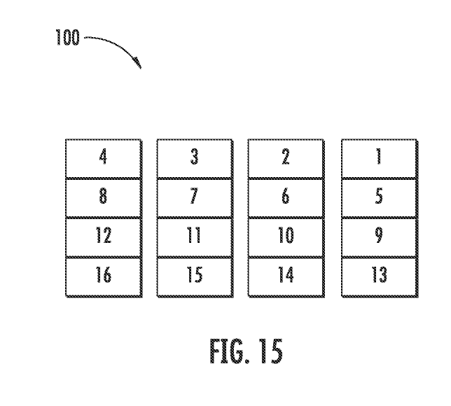

The result of assembling a group of four vertical stacks of chocolate molding trays 100 is shown in FIG. 15. The vertical stacks of the group of assembled vertical stacks of chocolate molding trays 100 were assembled in parallel by adding each successive chocolate molding tray to a bottom of a corresponding vertical stack. The numbers represent the order in which the chocolate molding trays 100 were added to their respective vertical stacks. Assembling the group of chocolate molding trays 100 in this fashion facilitates easy disassembly while maintaining a FIFO path through the chocolate cooler.

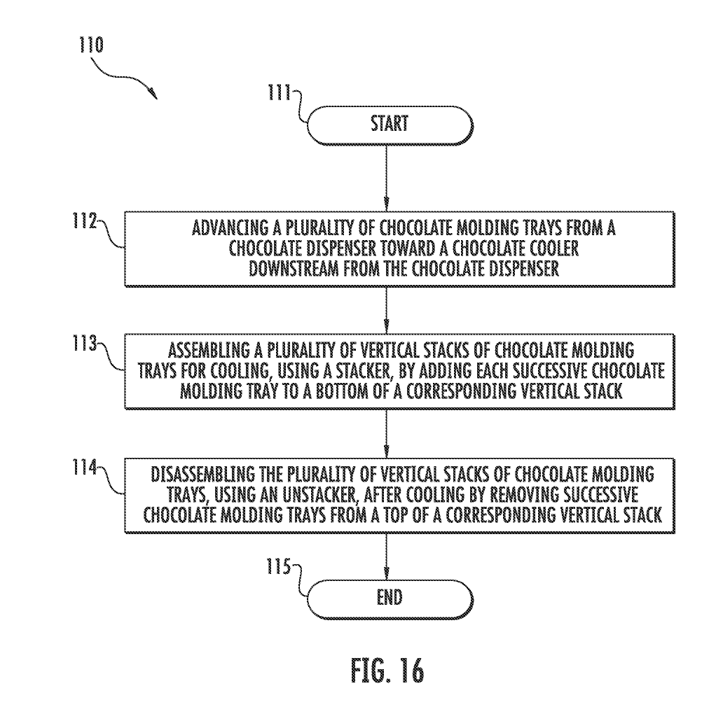

With additional reference to the flowchart 110 of FIG. 16, a method of making chocolate using a chocolate manufacturing apparatus is now described. After the start (at Block 111), at Block 112, a plurality of chocolate molding trays are advanced from a chocolate dispenser toward a chocolate cooler downstream from the chocolate dispenser.

At Block 113, a plurality of vertical stacks of chocolate molding trays are assembled for cooing, using a stacker, by adding each successive chocolate molding tray to a bottom of a corresponding vertical stack. At Block 114, the plurality of vertical stacks of chocolate molding trays are disassembled, using an unstacker, after cooling by removing successive chocolate molding trays from a top of a corresponding vertical stack. Block 115 indicates the end of the method.

Other features relating to the field of chocolate production may be found in co-pending applications CHOCOLATE MANUFACTURING APPARATUS INCLUDING WALKING BEAM CONVEYOR AND ASSOCIATED METHODS, Attorney Docket No. 60388 and CHOCOLATE MANUFACTURING APPARATUS INCLUDING STACKER AND UNSTACKER AND ASSOCIATED METHODS, Attorney Docket No. 60389, the entire disclosures of which are hereby incorporated by reference.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A chocolate manufacturing apparatus comprising:
a chocolate dispenser;
a chocolate cooler downstream from said chocolate dispenser;
a plurality of chocolate molding trays, each having a face defining at least one chocolate mold cavity and having a back opposite the face;
a conveyor to advance the plurality of chocolate molding trays from said chocolate dispenser to said chocolate cooler;
a plurality of face alignment features associated with the face of each chocolate molding tray; and
a plurality of back alignment features associated with the back of each chocolate molding tray;
said pluralities of face and back alignment features permitting alignment of an adjacent pair of chocolate molding trays in a face-to-face, back-to-back, and face-to-back relationship.

2. The chocolate manufacturing apparatus of claim 1, wherein said pluralities of face and back alignment features permit vertical stacking and unstacking of adjacent pairs of said chocolate molding trays but limit horizontal movement thereof.

3. The chocolate manufacturing apparatus of claim 1, wherein each of said plurality of chocolate molding trays has a generally rectangular base and a pair of opposing sidewalls extending therefrom.

4. The chocolate manufacturing apparatus of claim 3, wherein said plurality of back alignment features are associated with said pair of opposing sidewalls.

5. The chocolate manufacturing apparatus of claim 3, wherein said plurality of face alignment features are associated with said generally rectangular base.

6. The chocolate manufacturing apparatus of claim 1, wherein said plurality of face alignment features comprises a set of face alignment recesses in the face and a set of face alignment projections on the face.

7. The chocolate manufacturing apparatus of claim 6, wherein said set of face alignment projections are movable between an extended position and a retracted position.

8. The chocolate manufacturing apparatus of claim 6, wherein said set of face alignment recesses are defined adjacent a perimeter of the face; and wherein said set of face alignment projections extend from the face adjacent the perimeter thereof.

9. The chocolate manufacturing apparatus of claim 6, wherein opposite pairs of face alignment recesses are offset from each other; and wherein opposite pairs of face alignment projections are offset from each other.

10. The chocolate manufacturing apparatus of claim 3, wherein said back alignment features comprise a set of back alignment recesses defined in said pair of opposing sidewalls and a set of back alignment projections extending from said pair of opposing sidewalls.

11. The chocolate manufacturing apparatus of claim 10, wherein said set of back alignment recesses are defined adjacent a perimeter of said pair of opposing sidewalls; and wherein said set of back alignment projections extend from said pair of opposing sidewalls adjacent the perimeter thereof.

12. The chocolate manufacturing apparatus of claim 3, wherein opposite pairs of back alignment recesses are offset from each other; and wherein opposite pairs of back alignment projections are offset from each other.

13. The chocolate manufacturing apparatus of claim 1, further comprising a chocolate vibration apparatus downstream of said chocolate dispenser and upstream of said chocolate cooler; and further comprising a chocolate separator downstream of said chocolate cooler.

14. A chocolate manufacturing apparatus comprising:
a chocolate dispenser;
a chocolate cooler downstream from said chocolate dispenser;
a plurality of chocolate molding trays, each comprising a generally rectangular base, defining at least one chocolate mold cavity, and a pair of opposing sidewalls extending therefrom;
a conveyor to advance the plurality of chocolate molding trays from said chocolate dispenser to said chocolate cooler;
a plurality of face alignment features associated with said generally rectangular base of each chocolate molding tray; and
a plurality of back alignment features associated with said pair of opposing sidewalls of each chocolate molding tray;
said pluralities of face and back alignment features permitting alignment of an adjacent pair of chocolate molding trays in a face-to-face, back-to-back, and face-to-back relationship;
said pluralities of face and back alignment features also permitting vertical stacking and unstacking of adjacent pairs of said chocolate molding trays but limiting horizontal movement thereof.

15. The chocolate manufacturing apparatus of claim 14, wherein said plurality of face alignment features comprises a set of face alignment recesses in said generally rectangular base and a set of face alignment projections on said generally rectangular base.

16. The chocolate manufacturing apparatus of claim 14, wherein said back alignment features comprise a set of back alignment recesses defined in said pair of opposing sidewalls and a set of back alignment projections extending from said pair of opposing sidewalls.

17. A chocolate molding tray for use in a chocolate manufacturing apparatus comprising a chocolate dispenser, a chocolate cooler downstream from the chocolate dispenser, and a conveyor to advance the chocolate molding tray from the chocolate dispenser to the chocolate cooler, the chocolate molding tray comprising:
a generally rectangular base, defining at least one chocolate mold cavity, and a pair of opposing sidewalls extending therefrom;
a plurality of face alignment features associated with said generally rectangular base; and
a plurality of back alignment features associated with said pair of opposing sidewalls;
said pluralities of face and back alignment features permitting alignment of the chocolate molding tray with an adjacent chocolate molding tray in a face-to-face, back-to-back, and face-to-back relationship.

18. The chocolate molding tray of claim 17, wherein said pluralities of face and back alignment features also permit vertical stacking and unstacking of the chocolate molding tray with an adjacent pairs chocolate molding tray but limit horizontal movement thereof.

19. The chocolate molding tray of claim 17, wherein said plurality of face alignment features comprises a set of face alignment recesses in said generally rectangular base and a set of face alignment projections on said generally rectangular base.

20. The chocolate molding of claim 17, wherein said back alignment features comprise a set of back alignment recesses defined in said pair of opposing sidewalls and a set of back alignment projections extending from said pair of opposing sidewalls.

21. A method of making a chocolate molding tray for use in a chocolate manufacturing apparatus comprising a chocolate dispenser, a chocolate cooler downstream from the chocolate dispenser, and a conveyor to advance the chocolate molding tray from the chocolate dispenser to the chocolate cooler, the method comprising:
forming a generally rectangular base, having at least one chocolate mold cavity, and a pair of opposing sidewalls extending therefrom;
forming a plurality of face alignment features associated with the generally rectangular base; and
forming a plurality of back alignment features associated with the pair of opposing sidewalls;
the pluralities of face and back alignment features permitting alignment of the chocolate molding tray with an adjacent chocolate molding tray in a face-to-face, back-to-back, and face-to-back relationship.

22. The method of claim 21, wherein the pluralities of face and back alignment features permit vertical stacking and unstacking of adjacent pairs of the chocolate molding trays but limit horizontal movement thereof.

23. The method of claim 21, wherein the back alignment features comprise a set of back alignment recesses defined in the pair of opposing sidewalls and a set of back alignment projections extending from the pair of opposing sidewalls.

24. The method of claim 21, wherein the plurality of face alignment features comprises a set of face alignment recesses in the generally rectangular base and a set of face alignment projections on the generally rectangular base.
